(19) United States
(12) Patent Application Publication
(10) Pub. No.: US 2012/0211023 A1
(43) Pub. Date: Aug. 23, 2012

(54) Method for Removing Deposits

(75) Inventors: Marcello Riva, Hannover (DE); Stefan Mross, Brussels (BE)

(73) Assignee: SOLVAY FLUOR GMBH, Hannover (DE)

(21) Appl. No.: 13/504,096

(22) PCT Filed: Oct. 28, 2010
(86) PCT No.: PCT/EP10/66408

§ 371 Date: Apr. 25, 2012

(30) Foreign Application Priority Data
Oct. 30, 2009 (EP) 09174705.5

(51) Int. Cl. B08B 9/08; B08B 7/04; B08B 5/00

(52) U.S. Cl. 134/1.1; 134/31; 134/22.1

(57) ABSTRACT

A method for removing a silicon hydride from the surface of a solid body which comprises treating the silicon hydride with a gas comprising molecular fluorine or reactive species generated from molecular fluorine.

The present patent application claims benefit of European Patent Appl. No 09174705.5 filed on Oct. 30, 2009, the entire contents of which is incorporated by reference into the present patent application.

The present invention relates to a method for removing deposits which is useful particularly as a chamber cleaning process.

Treatment chambers are used in the semiconductor and photovoltaic industry to manufacture semiconductors, flat panel displays or photovoltaic elements. The manufacture generally comprises operations such as etching or chemical vapor deposition of a substrate which, during the treatment, is typically located on a support provided inside the treatment chamber.

During the manufacturing steps, in particular during chemical vapor deposition steps, materials are generally deposited not only on the substrate but also on interior parts of the chamber such as the chamber walls and counter electrodes. In order to prevent contamination problems during subsequent manufacturing runs, such materials are suitably removed.

EP-A-1138802 discloses that amorphous silicon deposited on inside parts of a treatment chamber can be cleaned thermally with fluorine as cleaning gas. This reference also teaches that silicon oxide or silicon nitride cannot be removed by this method.

The present invention now makes available in particular an efficient chamber cleaning process.

The invention concerns in consequence a method for removing silicon hydride from the surface of a solid body which comprises treating the silicon hydride with a gas comprising molecular fluorine. Alternatively the silicon hydride can be treated with or reactive species generated from molecular fluorine.

Surprisingly, molecular fluorine is particularly efficient for removal of silicon hydrides thus allowing for good cleaning efficiency and reduced cleaning time. Fluorine gas has no global warming potential and may be used with relatively low energy consumption compared for example to conventionally used NF₃ cleaning gas, while efficiently removing the silicon hydride deposits. “Silicon hydride” is understood to denote in particular a solid containing silicon and hydrogen. The hydrogen atom content in the solid phase is generally less than 1 mole per mole of silicon. This content is generally equal to or higher than 0.01 mole/mole silicon. Often this content is equal to or higher than 0.1 mole/mole silicon.

Often, the concentration of H in the Silicon Hydride is between 0.1 and 0.35 mole/mole silicon in an amorphous phase. It is typically between 0.03 and 0.1 mole/mole silicon in a microcrystalline phase.

“reactive species” is understood to denote in particular a fluorine containing plasma or atomic fluorine.

“generated from molecular fluorine” is understood to denote in particular that molecular fluorine (F₂) is initially present in the gas used to generate the reactive species.

Typically, the silicon hydride has been deposited on the surface of the solid body by chemical vapor deposition using a silane containing deposition gas. Typically the deposition gas comprises a silane and hydrogen. Examples of suitable silanes include SiH₄ and Si₂H₆. When a deposition gas comprising a silane and hydrogen is used, the silane content in the deposition gas is generally at least 50%, often at least 60%. When a deposition gas comprising silane and hydrogen is used, the silane content in the deposition gas is generally at most 90%, often equal to or less than 80%.

EP-A-1138802 teaches that it carries out a plasma CVD process with silane and hydrogen to form an amorphous silicon layer. The materials which are removed in the present invention are silicon hydrides, in particular as defined above. The deposition process can be carried out so as to control the hydrogen content of the silicon hydride and the crystallinity thereof.

The silicon hydrides which can be removed by the method of the invention are generally selected from amorphous and microcrystalline silicon hydrides. In one aspect the silicon hydrides consist essentially of amorphous silicon hydride.

In another aspect the silicon hydrides consist essentially of microcrystalline silicon hydride. In yet another aspect, the silicon hydrides comprise amorphous and microcrystalline silicon hydride.

In the present invention, molecular fluorine (F₂) is used as an essential component of the gas.

In one, preferred, aspect, the gas consists or consists essentially of molecular fluorine. In another aspect, a mixture comprising molecular fluorine and e.g. an inert gas, such as nitrogen, argon, xenon or mixtures thereof, in particular mixtures of nitrogen, argon and molecular fluorine, is used. In this case, the content of molecular fluorine in the mixture is typically equal to or less than 50% molar. Preferably, this content is equal to or less than 20% molar. Suitable mixtures are disclosed for example in WO 2007/116033 in the name of the applicant, the entire content of which is incorporated by reference into the present patent application. A particular mixture consists essentially of about 10% molar Argon, 70% molar nitrogen, and 20% molar F₂.

In a particular embodiment of this aspect, the content of molecular fluorine in the mixture with an inert gas as described above is more than 50% molar. Preferably, this content is equal to or more than 80% molar, for example about 90% molar. In this particular embodiment, argon is a preferred inert gas. A mixture consisting of about 90 molar % molecular fluorine and about 10 molar % argon is more particularly preferred. In this particular embodiment of this aspect, the content of molecular fluorine in the mixture with an inert gas as described above is equal to or lower than 95% molar.

Molecular fluorine for use in the present invention can be produced for example by heating suitable fluorometallates such as fluoronickelate or manganese tetrafluoride. Preferably, the molecular fluorine is produced by electrolysis of a molten salt electrolyte, in particular a potassium fluoride/hydrogen fluoride electrolyte, most preferably KF.2HF.

Preferably, purified molecular fluorine is used in the present invention. Purification operations which are suitable to obtain purified molecular fluorine for use in the invention include removal of particles, for example by filtering or absorption and removal of starting materials, in particular HF, for example by absorption, and impurities such as in particular CF₄ and O₂. Typically, the HF content in molecular fluorine used in the present invention is less than 10 ppm molar. Typically, the fluorine used in the present invention contains at least 0.1 molar ppm HF.

In a preferred embodiment, purified molecular fluorine for use in the present invention is obtained by a process comprising
(a) electrolysis of a molten salt, in particular as described above, to provide crude molecular fluorine containing HF, particles and optional impurities;
(b) an operation to reduce the HF content relative to the HF content of crude molecular fluorine, comprising for example an adsorption on sodium fluoride and preferably reducing the HF content in the molecular fluorine to the values mentioned here before;
(c) an operation to reduce the particle content relative to the particle content of crude molecular fluorine, comprising for example passing a fluorine stream containing particles through a solid absorbent such as for example sodium fluoride.

The molecular fluorine, in particular produced and purified as described here before, can be supplied to the method according to the invention, for example, in a transportable container. This method of supply is preferred when mixtures of fluorine gas with an inert gas in particular as described above are used in the method according to the invention.

Alternatively, the molecular fluorine can be supplied directly from its manufacture and optional purification to the method according to the invention, for example through a gas delivery system connected both to the silicon hydride removal step and to the fluorine manufacture and/or purification. This embodiment is particularly advantageous, if the gas used in the method according to the invention consists or consists essentially of molecular fluorine.

In the method according to the invention, the solid body generally comprises or consists of an electrically conductive material such as for example aluminum, or aluminum alloys in particularly aluminum/magnesium alloys, stainless steel and silicon carbide. Aluminum and aluminum alloys are preferred. In a preferred embodiment, the solid body is an interior part of a treatment chamber for manufacture of semiconductors, flat panel displays or photovoltaic elements. In a particular aspect, the solid body is an electrode suitable to create an electrical field in a CVD process, which is preferably made of electrically conductive material in particular such as described above.

The method according to the invention is particularly suitable for cleaning silicon hydride deposits in process chambers used for the manufacture of photovoltaic elements.

In a first particular embodiment of the method according to the invention, the treatment comprises generating a plasma from the gas. Certain plasma generators are known. A typical method to generate the plasma comprises exposing the gas to a high-frequency electrical field.

In a first aspect of the first particular embodiment, the frequency of the generated field is from 10 to 15 MHz. A typical frequency is 13.56 MHz.

In a second aspect of the first particular embodiment, the frequency of the generated field is from 40 to 100 MHz, preferably 40 to 80 MHz. A typical frequency is selected from 40 MHz and 60 MHz. The invention concerns also a plasma which has been obtained by exposing a molecular fluorine containing gas as described above, in particular a gas consisting or consisting essentially of molecular fluorine to a high-frequency electrical field having a frequency of from 40 to 80 MHz. The invention concerns also the use of such plasma to clean a treatment chamber used in a semiconductor, a flat panel display or a photovoltaic element manufacturing process.

In the first particular embodiment of the method according to the invention, the gas pressure is generally from 0.5 to 50 Torr, often from 1 to 10 Torr and preferably equal to or less than 5 Torr.

In the first particular embodiment of the method according to the invention, the residence time of the gas is generally from 1 to 180 s, often from 30 to 70 s and preferably from 40 to 60 s.

In the first particular embodiment of the method according to the invention, the power applied to generate the plasma is generally from 1 to 100000 W, often from 5000 to 60000 W and preferably from 10000 to 40000 W.

It is understood that these particular conditions also apply to the plasma according to the invention and the use according to the invention.

In one aspect of the first particular embodiment, the treatment is carried out by the remote plasma technology. In another aspect of this embodiment, an in-situ plasma is generated. For example, such in-situ plasma is generated inside a treatment chamber comprising a device suitable for generating a plasma from the gases described above, in particular from purified molecular fluorine. Suitable devices include, for example, a pair of electrodes capable of generating a high frequency electrical field.

In a second particular embodiment of the method according to the invention, the treatment comprises contacting the silicon hydride with the gas at an elevated temperature. Typical temperatures in this embodiment range from 100° C. to 300° C. Often the temperature is from 150° C. to 250° C. A temperature equal to or lower than 200° C. is preferred.

In one aspect, the temperature is realized by heating up the solid body to the desired temperature. In another aspect the gas may be heated for example by flowing it through a heated tube. The heated gas may also be generated in situ, for example by applying a high frequency field such as described above, in particular having a frequency from 40 to 60 MHz under conditions insufficient to generate a plasma. In a particular aspect, the gas is introduced into the treatment step so as generate a reaction heat which contributes to or achieves keeping the temperature of the solid body at a desired value. In particular when the gas consists or consists essentially of molecular fluorine, its introduction into the treatment step is preferably controlled so as to keep the temperature at most 300° C., preferably at most 250° C.

In the second particular embodiment of the method according to the invention, the gas pressure is generally from 50 to 500 Torr, often from 75 to 300 Torr and preferably from 100 to 200 Torr.

In the second particular embodiment of the method according to the invention, the residence time of the gas is generally from 50 to 500 s, often from 100 to 300 s and preferably from 150 to 250 s.

In the method according to the invention and the particular embodiments thereof, the treatment is generally carried out for a time sufficient to reduce the quantity of silicon hydride on the surface to less than 1% preferably less than 0.1% relative to its initial content.

The invention concerns also a process for the manufacture of a product wherein at least one treatment step for the manufacture of the product is carried out in a treatment chamber and silicon hydride is deposited on interior parts of the treatment chamber, for example on an electrode, which process comprises cleaning said interior part by the method according to the invention. Typically, the manufacture of the product comprises at least one chemical vapor deposition step of amorphous and/or microcrystalline silicon hydride, as described above, onto a substrate. Typical products are selected from a semiconductor, a flat panel display and a photovoltaic element such as a solar panel.

The examples here after are intended to illustrate the invention without however limiting it.

### EXAMPLES

The hydrogen concentration in Si-H in the examples here after is indicated as molar percentage.

### Example 1

### Remote Plasma Cleaning with Molecular Fluorine

In the manufacture of a solar panel a chemical vapor deposition step using silane gas and H₂ and doping gases containing PH₃ is carried out to deposit a silicon containing layer on a panel substrate mounted on a support within a treatment chamber having inside walls made of aluminum alloy. Depending upon deposition conditions and concentration of reagents, it is observed that after the PECVD step, microcrystalline or amorphous Si:H deposits are present on the inside walls and on the counter electrode of the chamber. The concentration of H in the Silicon Hydride is between 10% and 25% in the amorphous phase, whilst it is between 3% and 10% in the microcrystalline phase. After removing the panel substrate from the chamber, a gas consisting essentially of molecular fluorine is introduced at 35 slm into the chamber thorugh a remote plasma (RPS) system (10 kW) at a pressure of 100 mb. After 3 min treatment, the microcrystalline and amorphous Si:H layer is substantially removed from the chamber walls and from the counter electrode.

### Example 2

### Remote Plasma Cleaning with Molecular Fluorine Mixture with Inert Gas

In the manufacture of a solar panel a chemical vapor deposition step using silane gas and H₂ and doping gases containing PH₃ is carried out to deposit a silicon containing layer on a panel substrate mounted on a support within a treatment chamber having inside walls made of aluminum alloy. Depending upon deposition conditions and concentration of reagents, it is observed that after the PECVD step, microcrystalline and/or amorphous Si:H deposits are present on the inside walls and on the counter electrode of the chamber. The concentration of H in the Silicon Hydride is between 10% and 25% in the amorphous phase, whilst it is between 3% and 10% in the microcrystalline phase. After removing the panel substrate from the chamber, a gas mixture consisting of molecular fluorine (20%) and nitrogen (70%) and Ar (10%) is introduced into the chamber at 35 slm through an RPS system (40 kW) at a pressure of 200 mbar After 10 min treatment, the microcrystalline and amorphous Si:H layer is substantially removed from the chamber walls and from the counter electrode.

### Example 3

### Thermal Cleaning with Molecular Fluorine

In the manufacture of a solar panel a chemical vapor deposition step using silane gas and H₂ and doping gases containing PH₃ is carried out to deposit a silicon containing layer on a panel substrate mounted on a support within a treatment chamber having inside walls made of aluminum alloy. Depending upon deposition conditions and concentration of reagents, it is observed that after the PECVD step, microcrystalline and/or amorphous Si:H deposits are present on the inside walls and on the counter electrode of the chamber. The concentration of H in the Silicon Hydride is between 10% and 25% in the amorphous phase, whilst it is between 3% and 10% in the microcrystalline phase. After removing the panel substrate from the chamber, a gas consisting essentially of molecular fluorine, previously heated to 200° C., is introduced into the chamber at 35 slm at a pressure of 220 mbar. After 2 min treatment, the microcrystalline and amorphous Si:H layer is substantially removed from the chamber walls and from the counter electrode.

### Example 4

### In Situ Plasma Cleaning with Molecular Fluorine

In the manufacture of a solar panel a chemical vapor deposition step using silane gas and H₂ and doping gases containing PH₃ is carried out to deposit a silicon containing layer on a panel substrate mounted on a support within a treatment chamber having inside walls made of aluminum alloy. Depending upon deposition conditions and concentration of reagents, it is observed that after the PECVD step, microcrystalline and/or amorphous Si:H deposits are present on the inside walls and on the counter electrode of the chamber. The concentration of H in the Silicon Hydride is between 10% and 25% in the amorphous phase, whilst it is between 3% and 10% in the microcrystalline phase. After removing the panel substrate from the chamber, a gas consisting essentially of molecular fluorine is introduced at 10 slm into the chamber at a pressure of 5 mb. The in situ plasma operating at 13.56 MHz source is activated and a stable plasma is reached. After 5 min treatment, the microcrystalline and amorphous Si:H layer is substantially removed from the chamber walls and from the counter electrode.

### Example 5

### In Situ Plasma Cleaning with Molecular Fluorine Mixture with Inert Gas

In the manufacture of a solar panel a chemical vapor deposition step using silane gas and H₂ and doping gases containing PH₃ is carried out to deposit a silicon containing layer on a panel substrate mounted on a support within a treatment chamber having inside walls made of aluminum alloy. Depending upon deposition conditions and concentration of reagents, it is observed that after the PECVD step, microcrystalline and/or amorphous Si:H deposits are present on the inside walls and on the counter electrode of the chamber. The concentration of H in the Silicon Hydride is between 10% and 25% in the amorphous phase, whilst it is between 3% and 10% in the microcrystalline phase. After removing the panel substrate from the chamber, a gas mixture consisting of molecular fluorine (20%) and nitrogen (70%) and Ar (10%) is introduced at 10 slm into the chamber at a pressure of 5 mb. The in situ plasma source is activated and a stable plasma is reached. After 20 min treatment, the microcrystalline and amorphous Si:H layer is substantially removed from the chamber walls and from the counter electrode

### Example 6

### In Situ Plasma Cleaning with Molecular Fluorine

In the manufacture of a solar panel a chemical vapor deposition step using silane gas and H₂ and doping gases containing PH₃ is carried out to deposit a silicon containing layer on a panel substrate mounted on a support within a treatment chamber having inside walls made of aluminum alloy. Depending upon deposition conditions and concentration of reagents, it is observed that after the PECVD step, microcrystalline and/or amorphous Si:H deposits are present on the inside walls and on the counter electrode of the chamber. The concentration of H in the Silicon Hydride is between 10% and 25% in the amorphous phase, whilst it is between 3% and 10% in the microcrystalline phase. The plasma source at high frequency (40 MHz) allows depositing the active aSi:H and μmSi:H at an improved rate and with good uniformity. After removing the panel substrate from the chamber, a gas consisting essentially of molecular fluorine is introduced at 10 slm into the chamber at a pressure of 5 mb. The in situ plasma source is activated and a stable plasma is reached. After 3 min treatment, the microcrystalline and amorphous Si:H layer is substantially removed from the chamber walls and from the counter electrode.

### Example 7

### In Situ Plasma Cleaning with Molecular Fluorine Mixture with Inert Gas

In the manufacture of a solar panel a chemical vapor deposition step using silane gas and H₂ and doping gases containing PH₃ is carried out to deposit a silicon containing layer on a panel substrate mounted on a support within a treatment chamber having inside walls made of aluminum alloy. Depending upon deposition conditions and concentration of reagents, it is observed that after the PECVD step, microcrystalline and/or amorphous Si:H deposits are present on the inside walls and on the counter electrode of the chamber. The concentration of H in the Silicon Hydride is between 10% and 25% in the amorphous phase, whilst it is between 3% and 10% in the microcrystalline phase. The plasma source at high frequency (40 MHz) allow depositing the active aSi:H and μmSi:H at an improved rate and with good uniformity. After removing the panel substrate from the chamber, a gas mixture consisting of molecular fluorine (20%) and nitrogen (70%) and Ar (10%) is introduced at 10 slm into the chamber at a pressure of 5 mb. The in situ plasma source is activated and a stable plasma is reached. After 15 min treatment, the microcrystalline and amorphous Si:H layer is substantially removed from the chamber walls and from the counter electrode

### Example 8

### In Situ Plasma Cleaning with Molecular Fluorine Mixture with Inert Gas

In the manufacture of a solar panel a chemical vapor deposition step using silane gas and H₂ and doping gases containing PH₃ is carried out to deposit a silicon containing layer on a panel substrate mounted on a support within a treatment chamber having inside walls made of aluminum alloy. Depending upon deposition conditions and concentration of reagents, it is observed that after the PECVD step, microcrystalline and/or amorphous Si:H deposits are present on the inside walls and on the counter electrode of the chamber. The concentration of H in the Silicon Hydride is between 10% and 25% in the amorphous phase, whilst it is between 3% and 10% in the microcrystalline phase. The plasma source at high frequency (60 MHz) allow depositing the active aSi:H and μmSi:H at an improved rate and with good uniformity. After removing the panel substrate from the chamber, a gas consisting essentially of molecular fluorine is introduced at 10 slm into the chamber at a pressure of 5 mb. The in situ plasma source is activated and a stable plasma is reached. After 2.5 min treatment, the microcrystalline and amorphous Si:H layer is substantially removed from the chamber walls and from the counter electrode.

### Example 9

### In Situ Plasma Cleaning with Molecular Fluorine Mixture with Inert Gas

In the manufacture of a solar panel a chemical vapor deposition step using silane gas and H₂ and doping gases containing PH₃ is carried out to deposit a silicon containing layer on a panel substrate mounted on a support within a treatment chamber having inside walls made of aluminum alloy. Depending upon deposition conditions and concentration of reagents, it is observed that after the PECVD step, microcrystalline and/or amorphous Si:H deposits are present on the inside walls and on the counter electrode of the chamber. The concentration of H in the Silicon Hydride is between 10% and 25% in the amorphous phase, whilst it is between 3% and 10% in the microcrystalline phase. The plasma source at high frequency (60 MHz) allow depositing the active a-Si:H and μc-Si:H at an improved rate and with good uniformity. After removing the panel substrate from the chamber, a gas mixture consisting of molecular fluorine (20%) and nitrogen (70%) and Ar (10%) is introduced at 10 slm into the chamber at a pressure of 5 mb. The in situ plasma source is activated and a stable plasma is reached. After 13 min treatment, the microcrystalline and amorphous Si:H layer is substantially removed from the chamber walls and from the counter electrode.

### Example 10

### In Situ Plasma Cleaning with Molecular Fluorine Mixture with Low Inert Gas Content (10% Ar)

Fluorine mixtures with low concentration of inert gas are of interest because they can be transported in bulk (tube trailers) almost preserving the high reactivity of pure fluorine.

In the manufacture of a solar panel a chemical vapor deposition step using silane gas and H₂ and doping gases containing PH₃ is carried out to deposit a silicon containing layer on a panel substrate mounted on a support within a treatment chamber having inside walls made of aluminum alloy. Depending upon deposition conditions and concentration of reagents, it is observed that after the PECVD step, microcrystalline and/or amorphous Si:H deposits are present on the inside walls and on the counter electrode of the chamber. The concentration of H in the Silicon Hydride is between 10% and 25% in the amorphous phase, whilst it is between 3% and 10% in the microcrystalline phase. The plasma source at high frequency (60 MHz) allow depositing the active a-Si:H and μc-Si:H at an improved rate and with good uniformity. After removing the panel substrate from the chamber, a gas mixture consisting of molecular fluorine (90%) and and Ar (10%) is introduced at 10 slm into the chamber at a pressure of 5 mb. The in situ plasma source is activated and a stable plasma is reached. After 2.5 min treatment, the microcrystalline and amorphous Si:H layer is substantially removed from the chamber walls and from the counter electrode. It has not been possible to measure any deviation in etching rate between pure fluorine and the above mentioned mixture.

1. A method for removing silicon hydride from the surface of a solid body, comprising: treating the silicon hydride with a gas comprising molecular fluorine or reactive species generated from molecular fluorine.

2. The method according to claim 1, wherein the silicon hydride is selected from the group consisting of amorphous silicon hydride and microcrystalline silicon hydride.

3. The method according to claim 1, wherein silicon hydride deposited on the surface of the solid body by chemical vapor deposition using a silane containing deposition gas is removed.

4. The method according to claim 1, wherein the solid body is an interior part of a treatment chamber for manufacture of semiconductors, flat panel displays, or photovoltaic elements.

5. The method according to claim 1, wherein the gas consists essentially of molecular fluorine.

6. The method according to claim 1, wherein the gas is a mixture of molecular fluorine and an inert gas preferably selected from the group consisting of nitrogen and argon.

7. The method according to claim 6, wherein the molecular fluorine content of the gas is from more than 50% molar to 95% molar, and wherein the inert gas content is from 5% molar to 50% molar.

8. (canceled)

9. The method according to claim 1, wherein the treatment comprises generating a plasma from the gas.

10. The method according to claim 9, wherein generating the plasma comprises exposing the gas to a high-frequency electrical field having a frequency of from 40 to 80 MHz.

11. The method according to claim 9, wherein the gas pressure is from 0.5 to 50 Torr.

12. The method according to claim 9, wherein the power applied to generate the plasma is from 5000 to 60000 W.

13. The method according to claim 1, wherein the treatment comprises contacting the silicon hydride with the gas at a temperature of from 100 to 300° C.

14. The method according to claim 13, wherein the gas pressure is from 50 to 500 Torr.

15. The method according to claim 13, wherein a heated gas is generated in situ by applying a high frequency field having a frequency from 40 to 100 MHz under conditions insufficient to generate a plasma.

16. The method according to claim 1, wherein the treatment is carried out for a time sufficient to reduce the amount of silicon hydride layer on the surface to less than 1% relative to its initial amount.

17. The method according to claim 1, wherein the solid body comprises or consists of a material selected from the group consisting of aluminum, aluminum alloy, stainless steel, and SiC.

18. The method according to claim 1, which further comprises a step of providing molecular fluorine by electrolysis of a molten salt electrolyte for said molecular fluorine to be used in said method.

19. A process for the manufacture of a product, comprising: carrying out at least one treatment step for the manufacture of the product in a treatment chamber; depositing silicon hydride on an interior part of the treatment chamber; and cleaning said interior part by the method according to claim 1.

20. The process according to claim 19, wherein the product is selected from the group consisting of a semiconductor, a flat panel display, and a solar panel.

21. The method according to claim 6, wherein the molecular fluorine content of the gas is from 80 to 90% molar, and wherein the inert gas content is from 10% molar to 20% molar.
